(19) United States
(12) Patent Application Publication
(10) Pub. No.: US 2016/0323421 A1
(43) Pub. Date: Nov. 3, 2016

(54) WIRELESS COMMUNICATION SYSTEM, SERVE AND BASE STATION

(71) Applicant: HITACHI, LTD., Tokyo (JP)

(72) Inventors: Yoshiki SAKURAI, Tokyo (JP); Takashi ISOBE, Tokyo (JP); Kenzaburo FUJISHIMA, Tokyo (JP)

(73) Assignee: HITACHI, LTD., Tokyo (JP)

(21) Appl. No.: 15/097,497

(22) Filed: Apr. 13, 2016

(30) Foreign Application Priority Data
Apr. 28, 2015 (JP) 2015-091269

(51) Int. Cl. H04L 29/06; H04L 12/26; H04L 5/00; H04W 24/08

(52) U.S. Cl. CPC H04L 69/163; H04W 24/08; H04L 43/0841; H04L 5/006

(57) ABSTRACT

When a TCP packet communication acceleration technique is applied to a wireless communication network, an acceleration effect is determined according to various pieces of information in real time, and acceleration control is dynamically performed to efficiently accelerate the communication by the use of the TCP of a wireless terminal present in the wireless communication network. A wireless communication system including at least one wireless terminal and at least one base station that communicates with the wireless terminal further includes an information collection server that collects various pieces of information from the base station and the wireless terminal. The base station includes a packet acceleration unit that accelerates a TCP packet communication, and the information collection server determines whether to accelerate the base station from the various pieces of information, or not, and controls the acceleration of the base station on the basis of its determination result.

### INCORPORATION BY REFERENCE

This application claims priority based on Japanese patent application, No. 2015-091269 filed on Apr. 28, 2015, the entire contents of which are incorporated herein by reference.

### BACKGROUND

The present invention relates to a wireless communication system, a server, and a base station, and more particularly to a wireless communication system, a server, and a base station, which include a technique in which in accelerating a transmission control protocol (TCP) packet communication in a wireless network, it is determined whether the TCP packet communication is dynamically accelerated, or not.

It is general that a communication between global bases is performed on a wide area network (WAN) line. The WAN line is a long distance, and, for example, when a contract of the line connecting the global bases is inexpensive, a line quality may be low, and an increase in a round trip time (RTT) or a packet loss rate (PLR) is assumed. For that reason, the communication performed between terminals of the respective bases is affected by the RTT or the PLR, and the communication speed may fall below a bandwidth secured in the contract. In particular, in a communicating using the TCP, it is assumed that a window size is changed on a data transmission side according to whether the RTT or the PLR is present, or not, it is determined that the network is congested at the time of increasing the RTT or at the time of detecting packet discard, and in order to decrease the window size, the communication speed may be decreased. As described above, in the line such as the WAN line where the RTT or the PLR is large, the communicating using the TCP tends to decrease the communication speed. In order to solve this problem, in Japanese Patent No. 5175982, a TCP packet is artificially operated on the data transmission side to realize a communication unlikely to depend on the RTT or the PLR, and the communication speed can be improved.

On the other hand, in the wireless communication network, because'the wireless terminal freely travels in a wireless communication area, the RTT or the PLR is always largely changed as compared with a fixed network. A wireless resource available by one base station is restricted, and the base station always schedules the wireless resource to be assigned to each wireless terminal on the basis of a channel quality indicator (CQI) of which the base station is notified by the wireless terminal.

### SUMMARY

In Japanese Patent No. 5175982, when the RTT or the PLR is large, the communication using the TCP can be accelerated. However, when a file size is small or when the RTT or the PLR is small, the acceleration effect may become low, or the effect may be reversed. When the file size is small, because a TCP packet communication is finished before the TCP packet communication is completely accelerated, when the acceleration process is performed during the communication, the effect may be reversed.

Up to now, there is no means for dynamically switching acceleration operation for the communication using the TCP to another when the communication transitions to a state in which the above-mentioned acceleration effect is low, or the effect is reversed under the circumstance where the RTT or the PLR is dynamically changed as in the wireless communication network.

The present invention has been made in view of the above circumstances, and therefore aims at effectively and dynamically controlling a packet communication of a wireless communication network.

According to the first solving means of the present invention, there is provided a wireless communication system, comprising:

a server having a server table that stores measurement information including network communication quality information, wireless communication quality information, and a measured throughput, an acceleration ratio, and a file size; and

a base station that starts or stops acceleration processing of a packet communication under a control from the server, wherein

upon receiving a packet communication start notice and a file size from a wireless terminal in a state where the acceleration processing of the base station stops, the server transmits a notification start notice to the base station,

the base station notifies the server of notification information including network communication quality information and wireless communication quality information,

the server calculates an acceleration ratio average indicative of an average of a plurality of acceleration ratios on the basis of a predetermined policy according to the notification information, the file size, and information stored in advance in the server table, performs acceleration determination for starting or stopping the acceleration processing of a packet communication of the wireless terminal according to the acceleration ratio average, and transmits an acceleration start request and an information acquisition start notice to the base station when it is determined that the acceleration processing starts, and

the base station starts the acceleration processing of the packet communication of the wireless terminal, and measures and stores measurement information including the network communication quality information, the wireless communication quality information, and the measured throughput at every predetermined time interval,

upon receiving a packet communication end notice from the wireless terminal, the server transmits an acceleration stop request and an information acquisition end notice to the base station,

the base station stops the acceleration processing of the packet communication of the wireless terminal, terminates the measurement of the measurement information, and transmits the plurality of measurement information measured during the acceleration processing to the server, and

the server calculates a theoretical throughput from the network communication quality information on the basis of the plurality of measurement information, divides the measured throughput by the theoretical throughput to obtain the acceleration ratio, and stores the measurement information, the acceleration ratio, and the file size in the server table at the every predetermined time interval.

According to the second solving means of the present invention, there is provided a server, comprising:

a server table that stores measurement information including network communication quality information, wireless communication quality information, and a measured throughput, an acceleration ratio, and a file size; and

a control unit that controls start or stop of acceleration processing for a base station, wherein

upon receiving a packet communication start notice and a file size from a wireless terminal in a state where the acceleration processing of the base station stops, the control unit transmits a notification start notice to the base station,

upon receiving notification information including network communication quality information and wireless communication quality information from the base station,

the control unit calculates an acceleration ratio average indicative of an average of a plurality of acceleration ratios on the basis of a predetermined policy according to the notification information, the file size, and information stored in advance in the server table, performs acceleration determination for starting or stopping the acceleration processing of a packet communication of the wireless terminal according to the acceleration ratio average, and transmits an acceleration start request and an information acquisition start notice to the base station when it is determined that the acceleration processing starts,

to make the base station start the acceleration processing of the packet communication of the wireless terminal, and measure and store measurement information including the network communication quality information, the wireless communication quality information, and the measured throughput at every predetermined time interval,

upon receiving a packet communication end notice from the wireless terminal, the control unit transmits an acceleration stop request and an information acquisition end notice to the base station,

when the base station stops the acceleration processing of the packet communication of the wireless terminal, terminates the measurement of the measurement information, and the control unit receives the plurality of measurement information measured during the acceleration processing from the base station,

the control unit calculates a theoretical throughput from the network communication quality information on the basis of the plurality of measurement information, divides the measured throughput by the theoretical throughput to obtain the acceleration ratio, and stores the measurement information, the acceleration ratio, and the file size in the server table at the every predetermined time interval.

According to the third solving means of the present invention, there is provided a base station, comprising:

a base station table that stores measurement information including network communication quality information, wireless communication quality information, and a measured throughput;

a control unit; and

a packet acceleration unit that starts or stops acceleration processing of a packet communication under a control from a server, wherein,

when the server receives a packet communication start notice and a file size from a wireless terminal in a state where the acceleration processing of the base station stops, upon receiving a notification start notice from the server,

the control unit notifies the server of notification information including network communication quality information and wireless communication quality information,

when the server calculates an acceleration ratio average indicative of an average of a plurality of acceleration ratios on the basis of a predetermined policy according to the notification information, the file size, information stored in advance in a server table that stores measurement information including network communication quality information, wireless communication quality information, and a measured throughput, an acceleration ratio, and a file size, performs acceleration determination for starting or stopping the acceleration processing of a packet communication of the wireless terminal according to the acceleration ratio average, upon receiving an acceleration start request and an information acquisition start notice from the server when it is determined that the acceleration processing starts,

the control unit starts the acceleration processing of the packet communication of the wireless terminal by the packet acceleration unit, and measures measurement information including the network communication quality information, the wireless communication quality information, and the measured throughput at every predetermined time interval, and stores the measurement information,

when the servers receives a packet communication end notice from the wireless terminal, upon receiving an acceleration stop request and an information acquisition end notice from the server,

the control unit stops the acceleration processing of the packet communication of the wireless terminal by the packet acceleration unit, terminates the measurement of the measurement information, and, by referring to the base station table, transmits the plurality of measurement information measured during the acceleration processing to the server,

to make the server calculate a theoretical throughput from the network communication quality information on the basis of the plurality of measurement information, divide the measured throughput by the theoretical throughput to obtain the acceleration ratio, and store the measurement information, the acceleration ratio, and the file size in the server table at the every predetermined time interval.

According to the present invention, it is possible to achieve effectively and dynamically controlling a packet communication of a wireless communication network.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating a configuration of a wireless communication system of an LTE;

FIG. 2 is a block diagram illustrating a configuration of a base station;

FIG. 3 is a block diagram illustrating a configuration of a wireless terminal;

FIG. 4 is a block diagram illustrating a configuration of an information collection server;

FIG. 5 is a diagram illustrating a state transition table of an acceleration state of the base station and an event associated with that state;

FIG. 6 is a sequence diagram for measuring an acceleration ratio of a TCP packet communication;

FIG. 7 is a sequence diagram when starting acceleration of a TCP packet communication on the basis of information of an information collection server;

FIG. 8 is a sequence diagram when stopping the acceleration of the TCP packet communication on the basis of the information of the information collection server;

FIG. 9 is a sequence diagram when acceleration is determined by the information collection server, and an acceleration state is not changed;

FIG. 10 is a diagram illustrating a table that is acquired and transmitted to the information collection server by the base station;

FIG. 11 is a diagram illustrating a table for managing information associated with an acceleration rate stored in the information collection server;

FIG. 12 is a flowchart illustrating a case in which the information collection server transmits a notification start notice and a notification end notice to the base station;

FIG. 13 is a flowchart illustrating a case in which the information collection server performs acceleration determination, and transmits an acceleration start request and an acceleration stop request to the base station; and

FIG. 14 is a diagram illustrating a table for managing a state of the wireless terminal by the information collection server.

### DESCRIPTION OF THE EMBODIMENTS

Hereinafter, an embodiment of the present invention will be described with reference to the accompanying drawings. The embodiment of the present invention is merely exemplary, and the present invention is not limited to the embodiment.

### 1. Outline

An example of a typical embodiment of the present invention will be described below. For example, a wireless communication system including at least one wireless terminal and at least one base station that communicates with the wireless terminal further includes a server that collects various pieces of information from the base station and the wireless terminal. The base station includes means for accelerating a TCP packet communication, and the server determines whether the base station accelerates the TCP packet communication from the various pieces of information, or not, and means for controlling the acceleration by the base station on the basis of its determination result.

### 2. Wireless Communication System

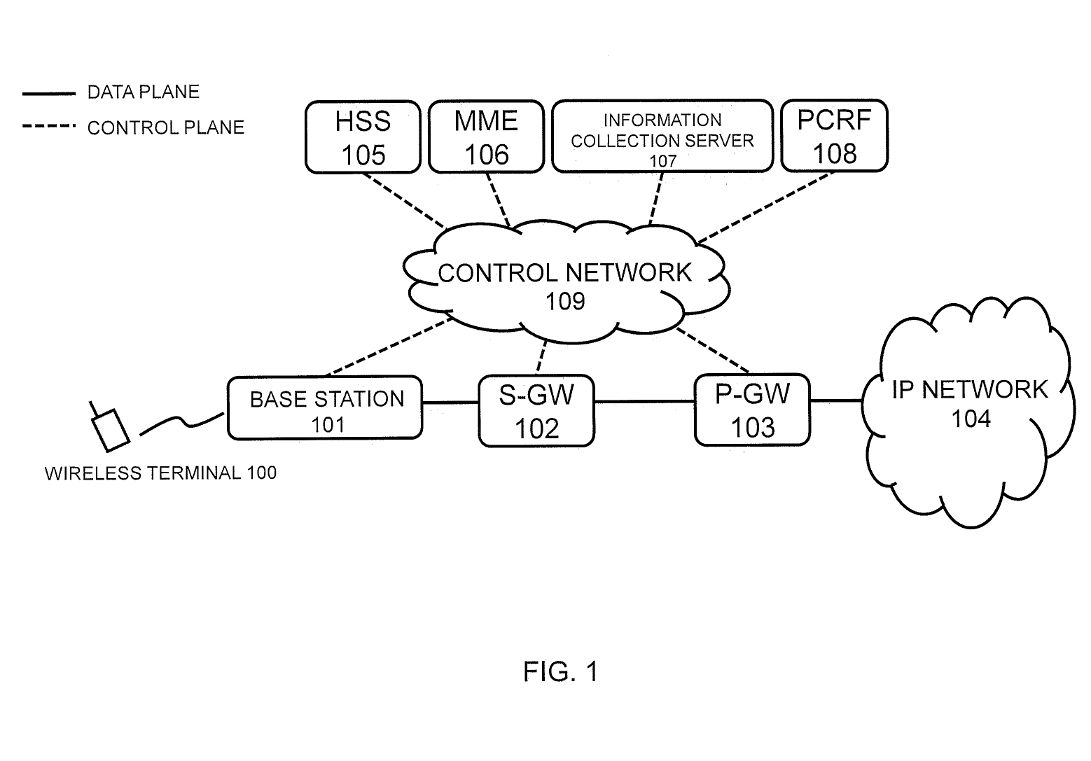

FIG. 1 is a block diagram illustrating a configuration of a wireless communication system of an LTE (long term evolution) according to the present embodiment. The LTE and a TCP are merely exemplary, and the present invention is not limited to the LTE and the TCP. The wireless communication system according to the present embodiment includes a wireless terminal 100, a base station 101, a serving gateway (S-GW) 102, a packet data network gateway (P-GW) 103, a home subscriber server (HSS) 105, a mobility management entity (MME) 106, an information collection server 107, and a policy and charging rule function (PCRF) 108. The base station 101, the S-GW 102, and the P-GW 103 are connected to each other by a data plane, and connected to an Internet protocol (IP) network 104 through the data plane that deals with a user packet. In addition, the base station 101, the S-GW 102, the P-GW 103, the HSS 105, the MME 106, the information collection server 107, and the PCRF 108 are connected to a control network 109 by a control plane that deals with a control signal. The wireless terminal 100 is connected to the base station 101, and performs a wireless communication with the base station 101 to perform both of user data and control communications. The MME 106 is a device that deals with only the control plane, manages positional information of the wireless terminal 100 in cooperation with the HSS 105, and manages a session with the wireless terminal 100. The S-GW 102 provides a function of routing and transferring a user packet. The P-GW 103 has a connection point with the IP network, and transfers the user packet with respect to the IP network. The PCRF 108 sets rules of a priority control and billing according to a service. In addition, although will be described later in detail, the information collection server 107 acquires various pieces of information from the wireless terminal 100 and the base station 101, accumulates the acquired information, and controls whether an acceleration function of the base station 101 is enabled (started) or disabled (stopped), on the basis of the accumulated information.

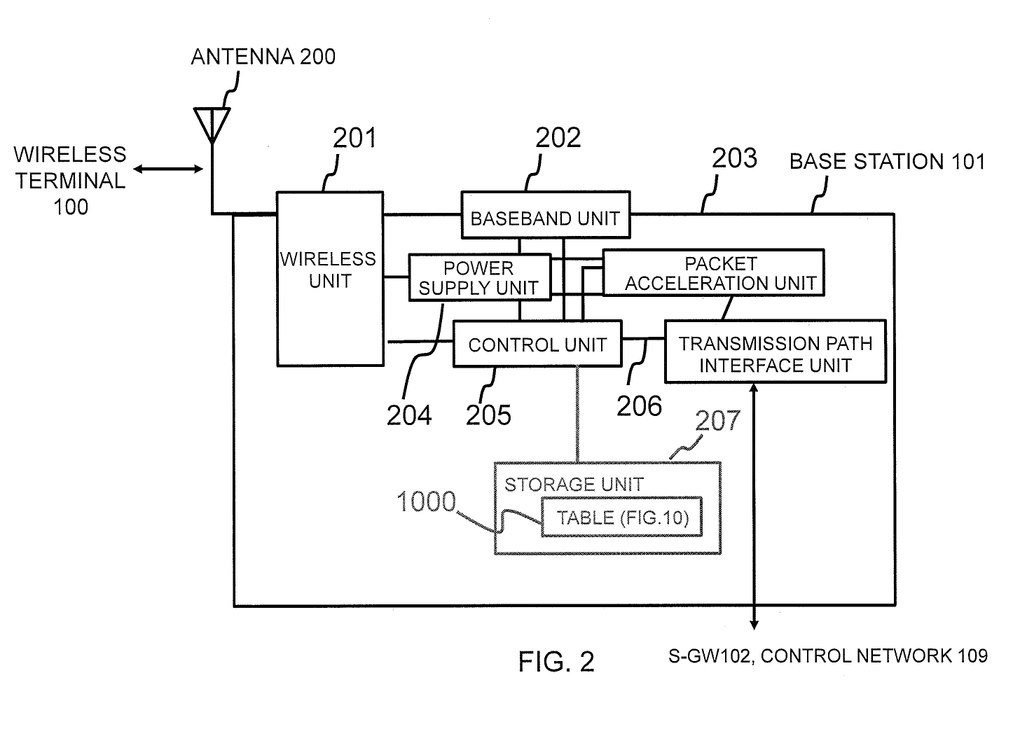

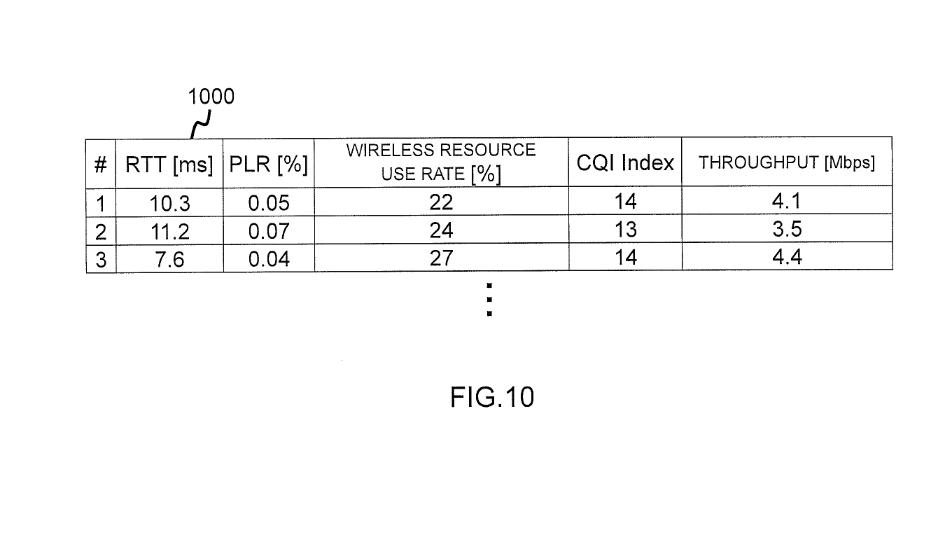

FIG. 2 is a block diagram illustrating a configuration of the base station 101 according to the present embodiment. The base station 101 according to the present embodiment includes an antenna 200 for performing a wireless communication with the wireless terminal 100, a wireless unit 201 that performs modulation, demodulation, and amplification of a wireless signal between the antenna 200 and a baseband unit 202, the baseband unit 202 that converts an IP packet received from a packet acceleration unit 203 and a baseband signal to be put on a radio, the packet acceleration unit 203 that accelerates a TCP packet communication received from a transmission path interface unit 206, a power supply unit 204 that supplies a power supply to all of the units, a control unit 205 that controls all of the units, the transmission path interface 206 that transfers the packets received from the S-GW 102 and a control network 109 to the packet acceleration unit 203, and a storage unit 207 that stores various pieces of information. The acceleration on/off operation of the packet acceleration unit 203 is controlled, for example, by the information collection server 107 through the control network 109, and the packet acceleration unit 203 executes the acceleration processing of the TCP packet communication when the packet acceleration unit 203 is on in acceleration. As will be described later, the control unit 205 measures and tabulates various pieces of information, and stores a table 1000 (refer to FIG. 10 to be described later) in the storage unit 207. In Japanese Patent No. 5175982, an acceleration device is located on each of transmission and reception sides. On the other hand, in the present embodiment, the acceleration device is located in only the base station 101, which is different from Japanese Patent No. 5175982. The detail will be described later.

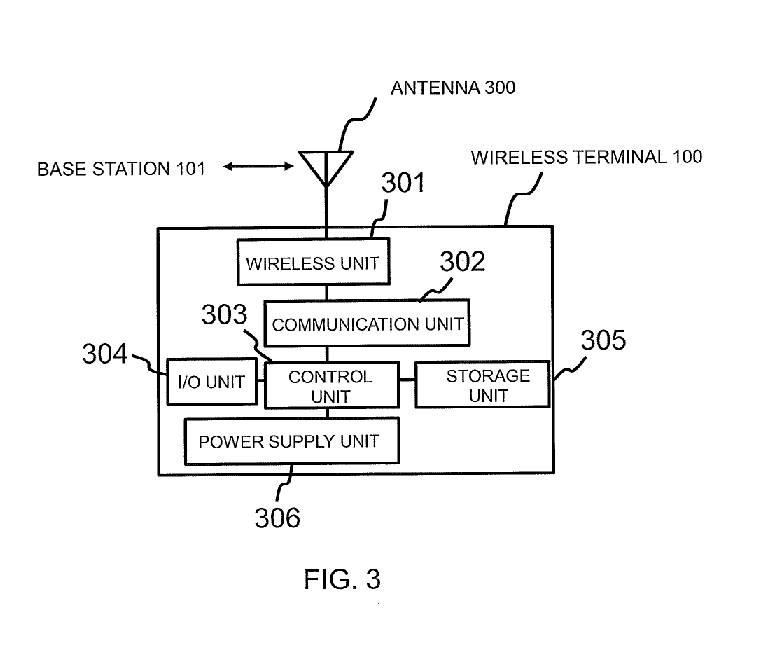

FIG. 3 is a block diagram illustrating a configuration of the wireless terminal 100 according to the present embodiment. The wireless terminal 100 according to the present embodiment includes an antenna 300 for communicating with the base station 101, a wireless unit 301, a communication unit 302 for modulating, demodulating, encoding, and decoding a signal, a control unit 303 for controlling the wireless terminal 100, an I/O unit 304 such as a keyboard for allowing a user to give an instruction to the wireless terminal 100, and such as a liquid crystal panel, a speaker, or a microphone for providing information to the user, a storage unit 305 that stores various pieces of information, and a power supply unit 306 for supplying a power supply to the respective units. In starting the TCP packet communication, the wireless terminal 100 acquires a size of a file to be downloaded in the TCP packet communication from an application or the like, and transmits the acquired file size to the information collection server 107 through the control network 109. In addition, in starting and ending the TCP packet communication, the wireless terminal 100 transmits TCP packet communication start and end notices to the information collection server 107. The detail will be described later.

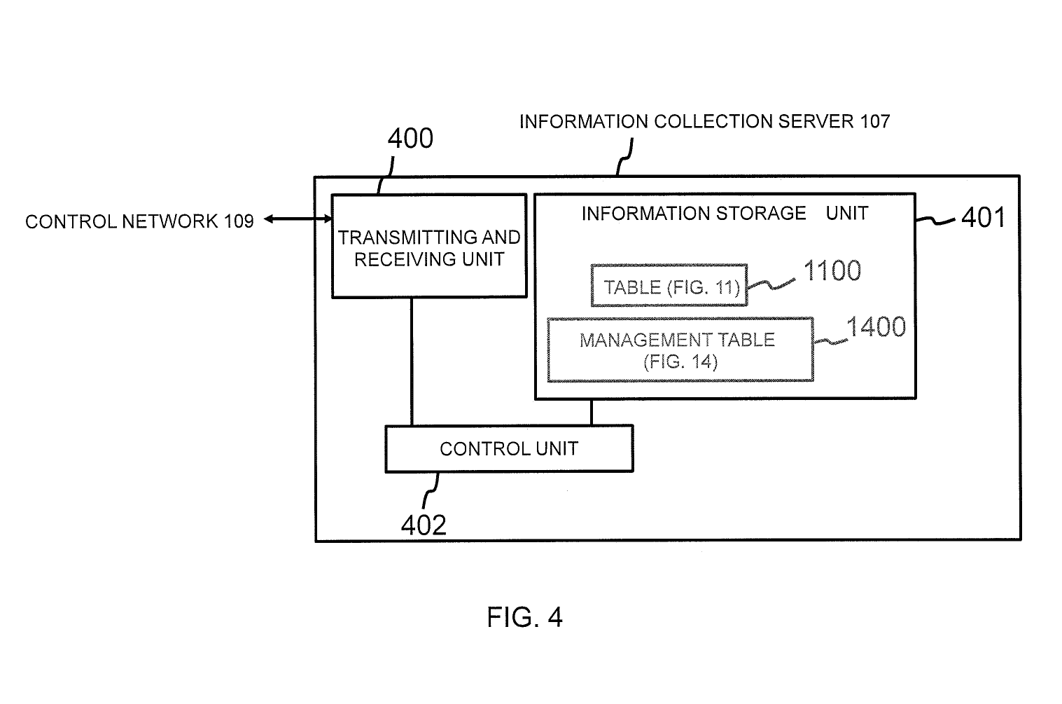

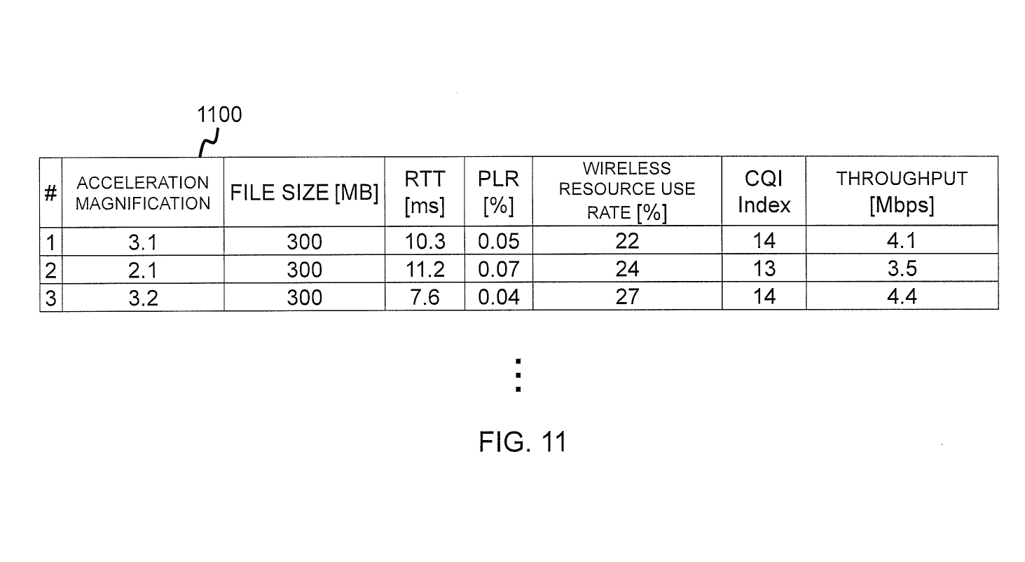

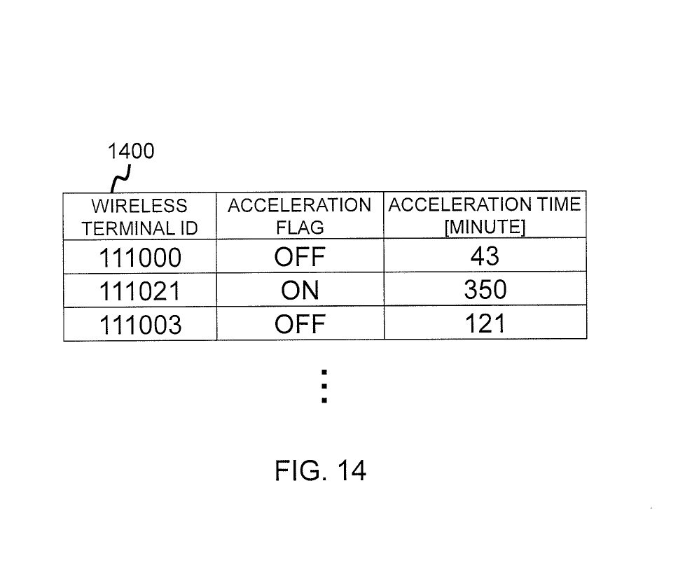

FIG. 4 is a block diagram illustrating a configuration of the information collection server 107 according to the present embodiment. The information collection server 107 according to the present embodiment includes a transmitting and receiving unit 400 that transmits and receives various pieces of information with respect to the wireless terminal 100 and the base station 101 through the control network 109, an information storage unit 401 that stores various pieces of information including information received from the wireless terminal 100 and the base station 101, and a control unit 402 that controls the information collection server 107. In addition, the control unit 402 tabulates the information received from the wireless terminal 100 and the base station 101, and stores a table 1100 (refer to FIG. 11 to be described later) in the information storage unit 401. The control unit 402 also determines whether to start or stop the acceleration of the TCP packet communication with the use of the table 1100, and controls the base station 101 through the transmitting and receiving unit 400 and the control network 109 on the basis of the determination result. The information storage unit 401 stores a management table 1400 (refer to FIG. 14 to be described later) for managing an acceleration state of the wireless terminal. The detail will be described later.

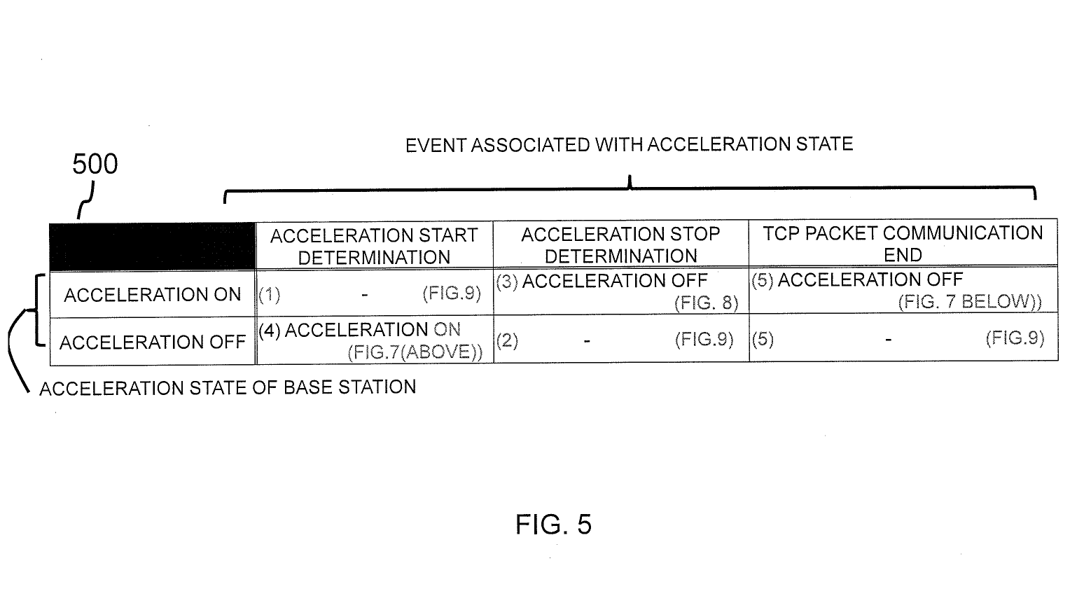

FIG. 5 illustrates a state transition table of a acceleration state of the base station 101 and an event associated with the acceleration state according to the present embodiment. The acceleration in the base station 101 is controlled by the information collection server 107 on the basis of the state transition table 500. In the state transition table 500, it is assumed that the TCP packet communication is performed. Hereinafter, a description will be made in correspondence with numbers indicated in parentheses in the figure.

(1) In the case where the acceleration state of the base station 101 is on in acceleration, when the information collection server 107 performs the acceleration start determination, because the base station 101 has been already on in acceleration, the information collection server 107 does not perform any processing.
(2) In the case where the acceleration state of the base station 101 is off in acceleration, when the information collection server 107 performs the acceleration stop determination, because the base station 101 has been already off in acceleration, the information collection server 107 does not perform any processing.
(3) In the case where the acceleration state of the base station 101 is on in acceleration, when the information collection server 107 performs the acceleration stop determination, the information collection server 107 requests the base station 101 to stop the acceleration, and turns off the acceleration state of the base station 101.
(4) In the case where the acceleration state of the base station 101 is off in acceleration, when the information collection server 107 performs the acceleration start determination, the information collection server 107 requests the base station 101 to start the acceleration, and turns on the acceleration state of the base station 101.
(5) Because the acceleration state of the base station 101 needs to be turned off even if the TCP packet communication is finished, when the acceleration state of the base station 101 is on, the information collection server 107 requests the base station 101 to stop the acceleration, and turns off the acceleration state of the base station 101. When the acceleration state of the base station 101 is off, because the base station 101 has been already off in acceleration, the information collection server 107 does not perform any processing.

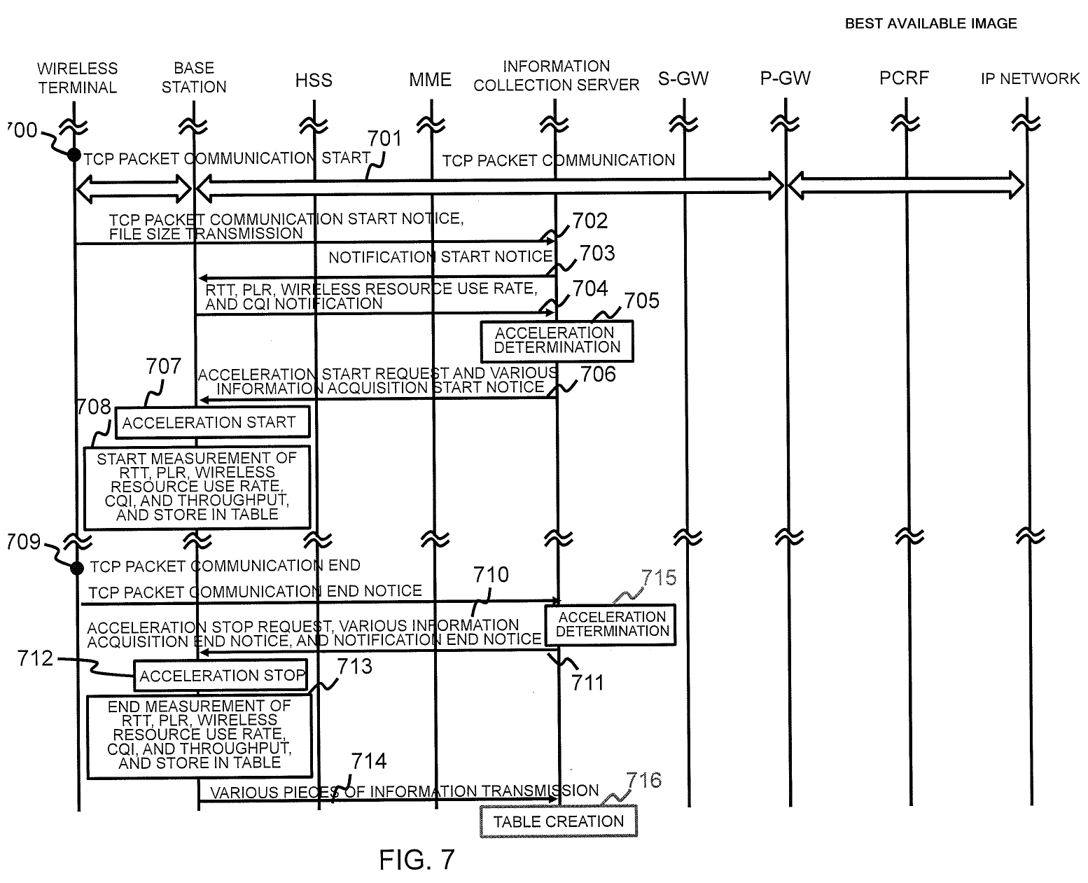

FIGS. 7 to 9 are sequence diagrams for controlling the acceleration of the base station 101 according to the state transition table 500. The detail will be described later.

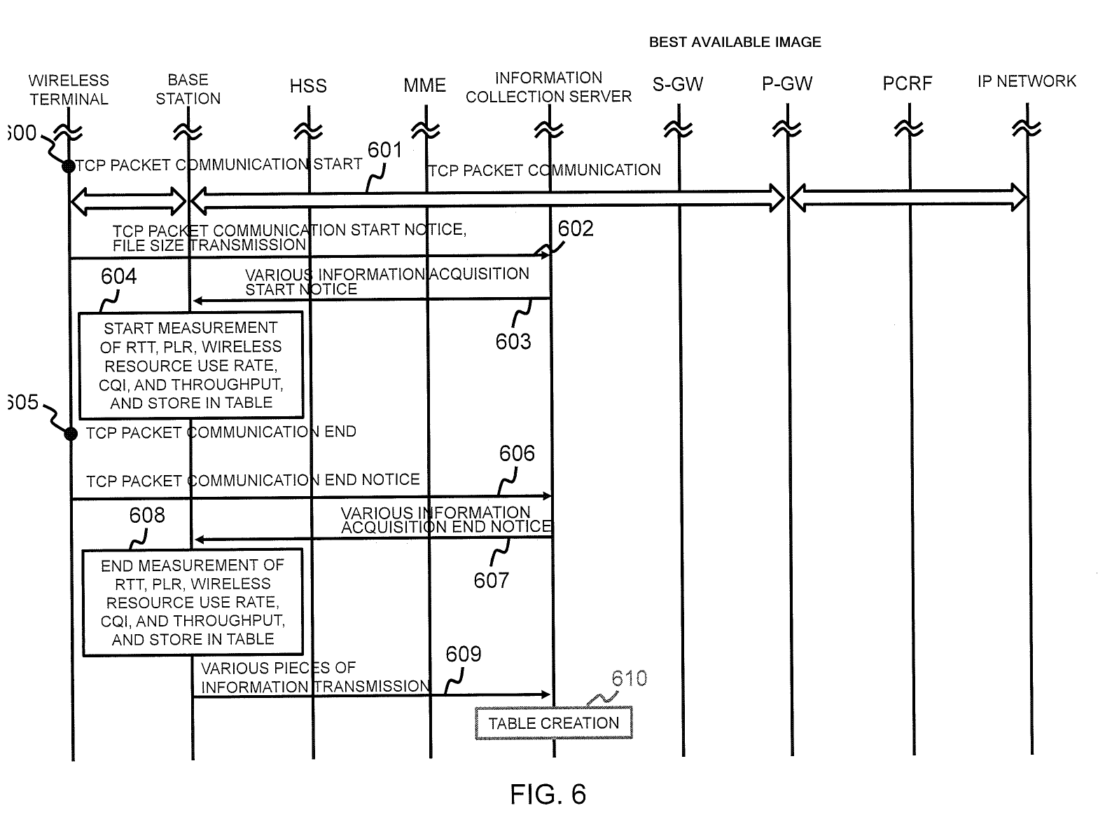

FIG. 6 is a sequence diagram illustrating a case in which an acceleration ratio of the TCP packet communication is measured according to the present embodiment. It is assumed that all of the TCP packet communications are accelerated in the base station 101, and a sample for determining the acceleration is to be collected. This sequence is executed at an appropriate time, for example, when a system is introduced, when the power supply starts to turn on, when initial setting is conducted, or when a table in FIG. 10 is initialized or set. When the wireless terminal 100 starts the TCP packet communication, a connection of the TCP packet communication is established (600, 601). Thereafter, the wireless terminal 100 notifies the information collection server 107 of a TCP packet communication start (including a wireless terminal ID), and transmits a size of a file received through the TCP packet communication to the information collection server 107 through the control network 109 (602). The information collection server 107 that has received a TCP packet communication start notice and the file size holds the file size and a time at which to receive the file size, and transmits various information acquisition start notices to the base station 101 (603). The base station 101 that has received the various information acquisition start notices starts the measurement of various pieces of information including the RTT, the PLR, a wireless resource use rate, a CQI, and a throughput (604). The base station 101 calculates, for example, an average of the respective information in a predetermined time, for example, in 30 seconds, and stores those calculated averages as one table. In the present embodiment, an example of 30 seconds will be described, but the present invention is not limited to this value.

FIG. 10 illustrates a table to be acquired and transmitted to the information collection server 107 by the base station 101. The table 1000 includes a data number #, the RTT, the PLR, the wireless resource use rate, the CQI, and the throughput in every predetermined time. The number of lines to be recorded can be appropriately determined to, for example, the number of lines from new data in advance. The data number # can be appropriately allocated by the base station 101 or the like.

For example, the base station 101 records a transmission sequence number of a TCP packet with data which has been transmitted to the wireless terminal 100 by the base station 101 and a transmission time of the TCP packet. The base station 101 records an acknowledgement number of Ack of the TCP packet received from the wireless terminal 100 by the base station 101 and a received time of the TCP packet, acquires a difference in time when the acknowledgement number is larger than the transmission sequence number. The base station 101 can record an average of those acquisition information acquired in 30 seconds in a table as the RTT every 30 seconds. The TCP packet with data represents a TCP packet with user data, and does not include TCP packets in starting a session of the other TCP packet communication. For example, the base station 101 records a transmission sequence number n1 of the TCP packet with data which has been transmitted to the wireless terminal 100 by the base station 101, and the base station 101 then records a transmission sequence number n2 of the TCP packet with data which is transmitted to the wireless terminal 100 by the base station 101. The base station 101 can record a rate at which n1>n2 is satisfied in 30 seconds in the table as the PLR every 30 seconds. In addition, for example, the base station 101 acquires the wireless resource use rate depending on a sampling time that can be acquired by the base station 101, and the base station 101 can record an average value of the wireless resource use rates in 30 seconds as the wireless resource use rate in the table every 30 seconds. The base station 101 acquires the CQI depending on the sampling time that can be acquired from the wireless terminal 100 by the base station 101, holds a value of efficiency associated with the CQI, and can record a CQI closest to an average of the efficiency values in 30 seconds as the CQI in the table every 30 seconds. The value of efficiency is, for example, an index indicating how much to obtain throughput at a frequency 1 Hz. The base station 101 can record a value obtained by dividing a total file size of the data packets transmitted to the wireless terminal 100 from the base station 101 by 30 seconds as a measured throughput in the table every 30 seconds. As described above, the base station 101 updates the table every predetermined time, for example, 30 seconds. However, the present invention does not need to be limited to this method.

When finishing the TCP packet communication, the wireless terminal 100 notifies the information collection server 107 of a TCP packet communication end notice (605, 606). The information collection server 107 that has received the TCP packet communication end notice transmits various information acquisition end notices to the base station 101, and the base station 101 that has received the various information acquisition end notices finishes the measurement of various pieces of information including the RTT, the PLR, the wireless resource use rate, the CQI, and the throughput (607, 608). Upon finishing the measurement, the base station 101 adds averages of the various pieces of information shorter than 30 seconds to the table, and transmits a table illustrated in FIG. 10 to the information collection server 107 (609). The information collection server 107 that has received the table of FIG. 10 creates and records a table of FIG. 11 (610).

FIG. 11 illustrates a table for managing information associated with the acceleration rate accumulated in the information collection server 107. The table 1100 includes the acceleration ratio, the file size, the RTT, the PLR, the wireless resource use rate, the CQI, and the throughput.

For example, the information collection server 107 adds the file sizes that have been received from the wireless terminal 100 in advance to the respective lines in the received table. Further, the information collection server 107 calculates a theoretical throughput from the RTT and the PLR on each line of the received table. The theoretical throughput can be obtained by multiplying an average number of congestion windows of the TCP by the number of bits in one packet, and dividing the multiplied numerical value by the RTT, for example, as disclosed in document (S. Floyd, “High Speed TCP for large Congestion Windows (registered trademark)”, IETF RFC3649, December 2003). A formula for obtaining the theoretical throughput according to the present embodiment is, for example, 1.2/sqrt(p)*MSS*8/r, where p is PLR, MSS is maximum segment size, and r is RTT. The MSS is determined at a 3-way handshake time when the TCP packet communication starts, and the base station 101 acquires a value of the MSS, and transmits the acquired value to the information collection server 107. The information collection server 107 calculates the acceleration ratio with the use of the theoretical throughput calculated in the information collection server 107 and the measured throughput described in the table. The acceleration ratio is calculated by the information collection server 107 by dividing the measured throughput by the theoretical throughput, and the information collection server 107 adds the acceleration ratio to the respective lines of the table. The table illustrated in FIG. 11 is created by the information collection server 107 through the above procedures. With the use of this table, the information collection server 107 performs the acceleration determination, and controls the base station 101. The detail will be described later. A period of the measurement of the acceleration rate using the sequence of FIG. 6 is determined by, for example, carriers or system designs, and a length of the period can be freely determined.

FIG. 7 is a sequence diagram illustrating a case in which the acceleration of the TCP packet communication starts on the basis of the information of the information collection server 107 according to the present embodiment. It is assumed that the TCP packet communication is being executed, and is not being accelerated. When the wireless terminal 100 starts the TCP packet communication, a session of the TCP packet communication is established (700, 701). Thereafter, the wireless terminal 100 notifies the information collection server 107 of a TCP packet communication start (including the wireless terminal ID), and transmits the file size to the information collection server 107 (702). The information collection server 107 that has received those pieces of information transmits a notification start notice to the base station 101 (703). The base station 101 that has received the notification start notice notifies the information collection server 107 of notification information including the RTT, the PLR, the wireless resource use rate, and the CQI, which are acquired by the base station 101, at fixed intervals (704). The step 704 is executed at predetermined fixed intervals. The notification information can be obtained by, for example, an average value in the fixed interval. The information collection server 107 that has received the notification information performs the acceleration determination on the basis of the notification information, the file size received from the base station 101 in advance, and the accumulated table 1100 (FIG. 11) (705). The detail of an acceleration determination method will be described later. When performing a determination for starting the acceleration, the information collection server 107 transmits an acceleration start request of the TCP packet communication of the wireless terminal 100 and the various information acquisition start notices to the base station 101 (706).

The base station 101 that has received those pieces of information starts to accelerate the TCP packet communication of the wireless terminal 100, starts to measure the RTT, the PLR, the wireless resource use rate, the CQI, and the throughput, and creates the table 1000 of FIG. 10 in the same method as that in FIG. 6 (707, 708). Thereafter, when the wireless terminal 100 finishes the TCP packet communication in a state where the acceleration of the base station 101 is continued, the wireless terminal 100 transmits a TCP packet communication end notice to the information collection server 107 (709, 710). The information collection server 107 that has received the TCP packet communication end notice performs the acceleration determination on the basis of an accumulated management table 1400 (FIG. 14) (715), and transmits an acceleration stop request of the TCP packet communication of the wireless terminal 100, the various information acquisition end notices, and a notification end notice to the base station 101 (711). The base station 101 that has received those pieces of information stops the acceleration of the TCP packet communication of the wireless terminal 100, finishes the measurement of the RTT, the PLR, the wireless resource use rate, the CQI, and the throughput, and finishes the notification to the information collection server 107 (712, 713). Thereafter, the base station 101 creates the table 1000 of FIG. 10 on the basis of the various pieces of information acquired during acceleration in the same method as that in FIG. 6, and transmits the created table to the information collection server 107 (714). The information collection server 107 that has received those pieces of information creates the table 1100 of FIG. 11 in the same method as that in FIG. 6 (715). In this sequence, the information collection server 107 acquires the various pieces of information in the same method as that in FIG. 6 in a state where the base station 101 is being accelerated, thereby being capable of updating the information of the information collection server 107.

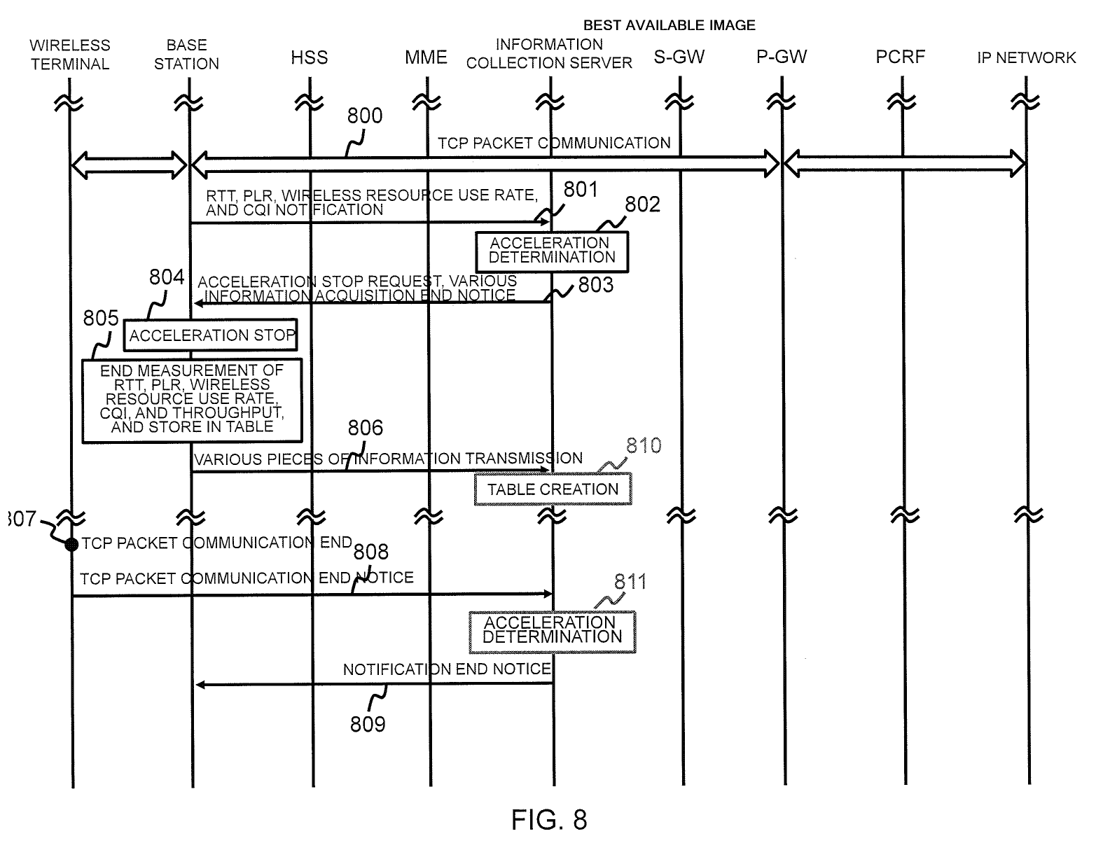

FIG. 8 is a sequence diagram illustrating a case in which the acceleration of the TCP packet communication stops on the basis of the information of the information collection server 107 according to the present embodiment. It is assumed that the TCP packet communication is being executed, and also being accelerated (800). In this state, the information collection server 107 receives the information notified from the base station 101 at fixed intervals, and performs the acceleration determination. When the information collection server 107 determines that the acceleration of the TCP packet communication of the wireless terminal 100 stops, the information collection server 107 transmits an acceleration stop request of the TCP packet communication of the wireless terminal 100 and the various information acquisition end notices to the base station 101 (801, 802, 803). The base station 101 that has received those information stops the acceleration, finishes the measurement of the RTT, the PLR, the wireless resource use rate, the CQI, and the throughput, creates the table of FIG. 10 on the basis of the various pieces of information acquired during acceleration in the same method as that in FIG. 6, and transmits the created table to the information collection server 107 (804, 805, 806). The information collection server 107 that has received those pieces of information creates the table of FIG. 11 in the same method as that in FIG. 6 (810). Thereafter, when the wireless terminal 100 finishes the TCP packet communication in a state where the base station 101 stops the acceleration, the wireless terminal 100 transmits a TCP packet communication end notice to the information collection server 107 (807, 808). The information collection server 107 that has received the TCP packet communication end notice performs the acceleration determination according to the wireless terminal ID included in the TCP packet communication start notice received in advance on the basis of the accumulated management table 1400 (FIG. 14) (811), and transmits a notification end notice to the base station 101, and the base station 101 finishes the notification of the notification information (809).

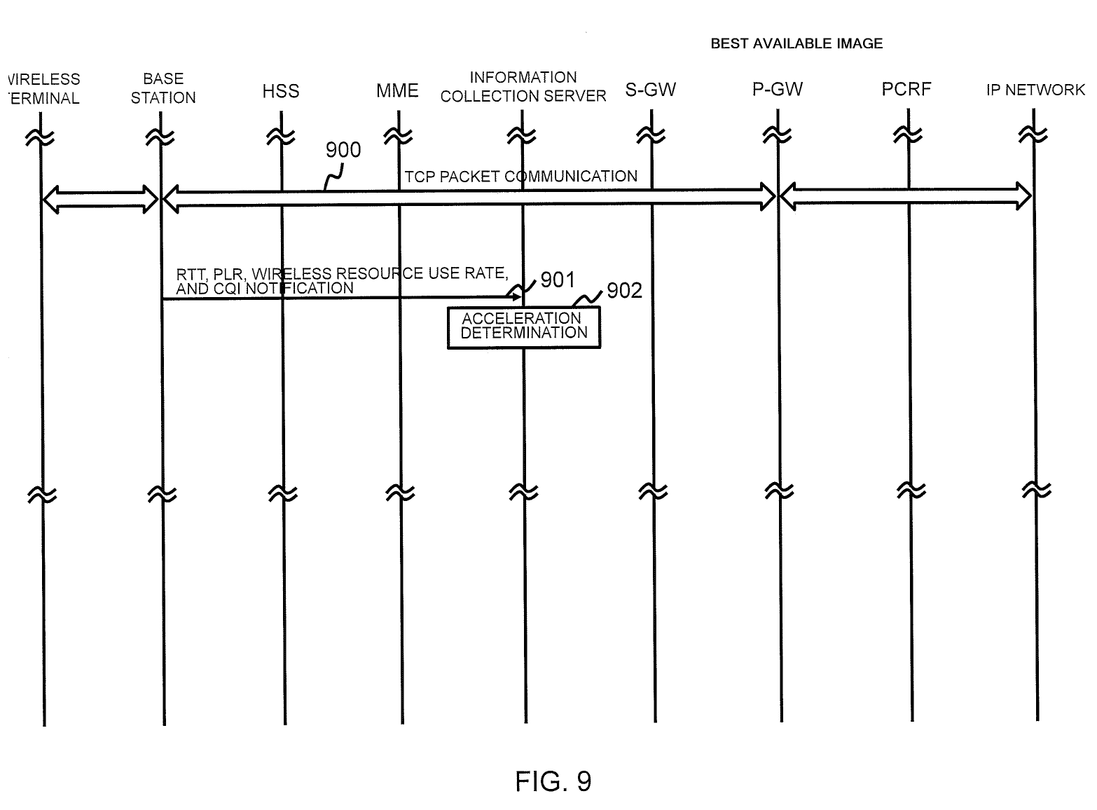

FIG. 9 is a sequence diagram illustrating a case in which the acceleration determination is performed by the information collection server 107, but an acceleration state is not changed according to the present embodiment. It is assumed that the wireless terminal 100 is executing the TCP packet communication, and is in a state where the acceleration is on or off (900). The base station 101 notifies the information collection server 107 of the notification information including the RTT, the PLR, the wireless resource use rate, and the CQI at predetermined fixed intervals, and the information collection server 107 that has received the notification information performs the acceleration determination (901, 902). In this situation, when an acceleration state of the base station 101 is identical with the determination result of the acceleration of the information collection server 107, the information collection server 107 does not perform a control based on the determination on the base station 101. As a result, an unnecessary communication between the information collection server 107 and the base station 101 can be excluded.

The respective sequence diagrams of FIGS. 7 to 9 operate on the basis of a state transition table of FIG. 5, and encompass state transitions of the respective events.

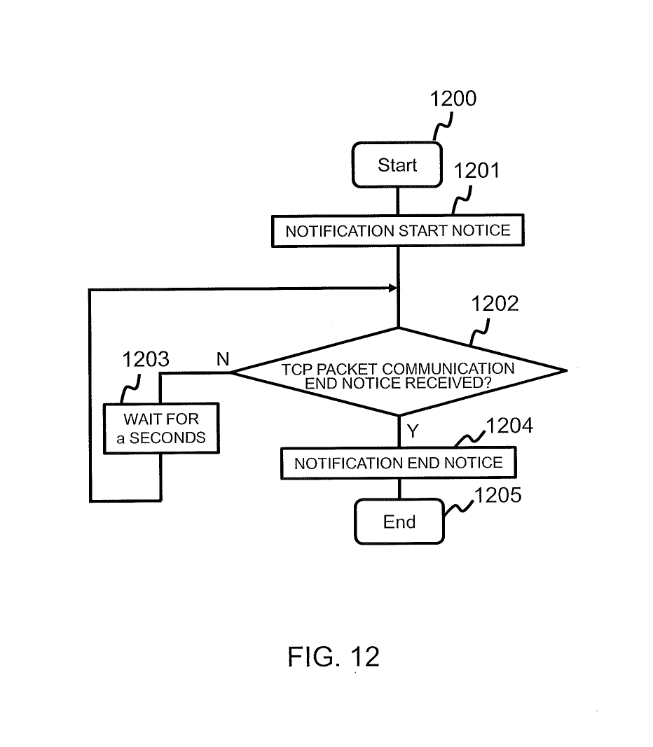

FIG. 12 is a flowchart illustrating a case in which the information collection server 107 transmits a notification start notice and a notification end notice to the base station 101 according to the present embodiment. Upon receiving the TCP packet communication start notice from the wireless terminal 100, the information collection server 107 starts this flowchart (1200). Then, the information collection server 107 transmits the notification start notice to the base station 101 (1201). Thereafter, the information collection server 107 determines whether to receive the TCP packet communication end notice from the wireless terminal 100, or not, and if not received, the information collection server 107 waits for a predetermined time, for example, a seconds, and returns to a flow of Step 1202 (1202). If the information collection server 107 receives the TCP packet communication end notice from the wireless terminal 100, the information collection server 107 transmits the notification end notice to the base station 101, and finishes the flowchart (1204, 1205). With the above flowchart, during the TCP packet communication of the wireless terminal 100, the information collection server 107 can receive the notification information including the RTT, the PLR, the wireless resource use rate, and the CQI from the base station 101 at the fixed intervals.

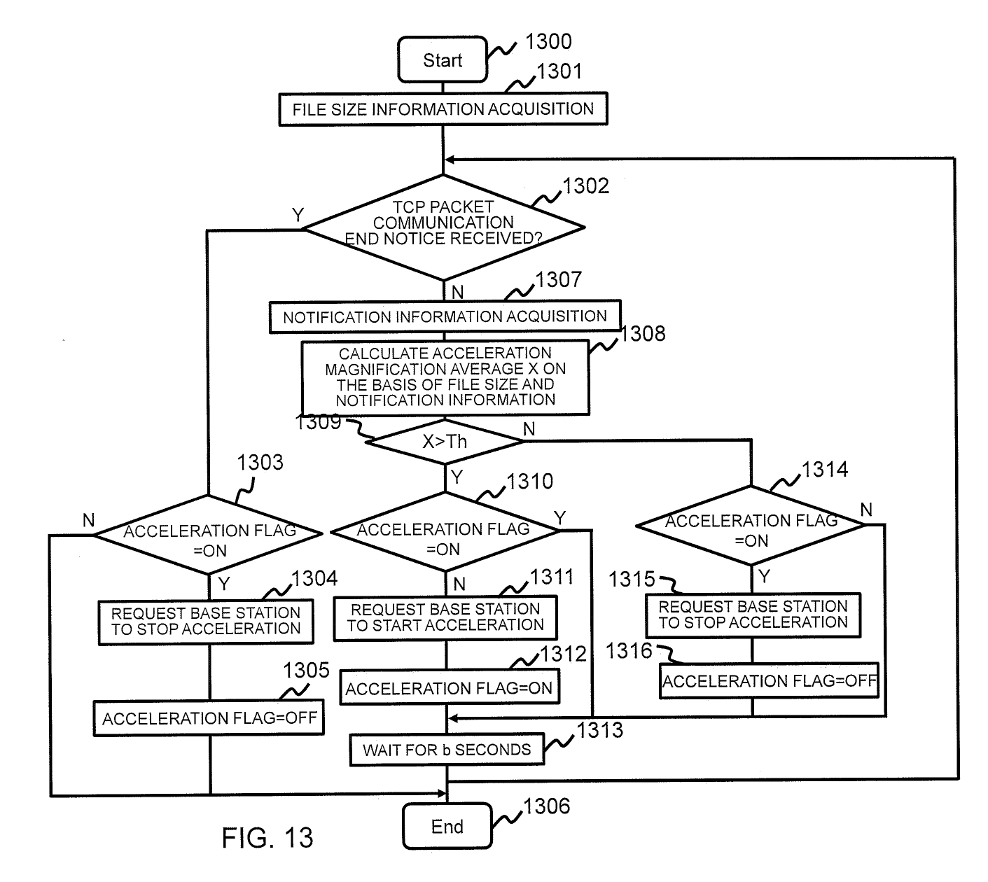

FIG. 13 is a flowchart illustrating a case in which the information collection server 107 performs the acceleration determination, and transmits an acceleration start request and an acceleration stop request to the base station 101 according to the present embodiment. Upon receiving the TCP packet communication start notice from the wireless terminal 100, the information collection server 107 starts this flowchart (1300). The information collection server 107 receives, for example, file size of a file to be downloaded from the wireless terminal 100 through the TCP packet communication with the use of the wireless terminal ID, and holds the file size (1301). Then, the information collection server 107 determines whether to receive the TCP packet communication end notice from the wireless terminal 100, or not, and if received, the information collection server 107 refers to the management table 1400 (refer to FIG. 14 to be described later) managed by the information collection server 107, and determines whether an acceleration flag corresponding to the wireless terminal 100 identified by the wireless terminal ID is on, or not (1302, 1303). If the acceleration flag corresponding to the wireless terminal 100 is on, because the wireless terminal 100 is in a state to be accelerated in the base station 101, the information collection server 107 transmits the acceleration stop request of the TCP packet communication of the wireless terminal 100 to the base station 101, turns off the acceleration flag corresponding to the wireless terminal 100, and finishes the flowchart (1304, 1305, 1306). On the other hand, if the acceleration flag corresponding to the wireless terminal 100 is off in Step 1303, because the wireless terminal 100 is in a state not to be accelerated in the base station 101, the information collection server 107 finishes the flowchart as it is.

If the information collection server 107 does not receive the TCP packet communication end notice from the wireless terminal 100 in Step 1302, the information collection server 107 acquires the information notified from the base station 101 at the fixed intervals (1307). Referring to the table 1100 of FIG. 11, the information collection server 107 calculates an acceleration ratio average X on the basis of the file size received from the wireless terminal 100 in Step 702 or the like, and the notification information (RTT, PLR, wireless resource use rate, and CQI) received from the base station 101 in Steps 704, 801, or 901 (1308).

A method of calculating the acceleration ratio average X roughly includes two steps. In a first step, the information in the table 1100 of FIG. 11 which is accumulated in the information collection server 107 is sorted on the basis of a predetermined policy (including a rule, a setting, a procedure, a process, an approach, and so on) according to the file size received from the wireless terminal 100 in Step 702 and the notification information received from the base station 101 in Step 704, 801, or 901, and an average of the higher acceleration ratios of the sorted results can be set as the acceleration ratio average X. For example, by the file size received from the wireless terminal 100 in Step 702, the table 1100 of FIG. 11 in the information collection server 107 is sorted in order closer to the file size, and the higher 500 information is then sorted in order closer to a numerical value of the RTT of the notification information received from the base station 101 in Step 704, 801, or 901. The higher 250 information is further sorted in order closer to a numerical value of the PLR of the notification information. In such flow, an average of the acceleration ratios of, for example, the higher 10 information among the information most consistent with the received file size and notification information in the table 1100 of FIG. 11 in the information collection server 107 is set as the acceleration ratio average X. The policy (sorting method) in the first step is not uniquely determined.

In a second step, the information collection server 107 calculates a bandwidth that can be assigned to the wireless terminal 100 according to the wireless resource use rate and the CQI of the notification information received from the base station 101 in Step 704, 801, or 901, and if the acceleration ratio average X obtained in Step 1 is lowered by an upper limit of the bandwidth, the information collection server 107 changes the acceleration ratio average X to a value derived from the upper limit of the bandwidth. Specifically, for example, the information collection server 107 calculates an area (throughput) that can be assigned to the wireless terminal 100 according to the wireless resource use rate and the CQI of the notification information received from the base station 101 in Step 704, 801, or 901, and calculates the theoretical throughput according to the RTT and the PLR of the notification information, for example, on the basis of the above-mentioned formula described in FIG. 6. The information collection server 107 compares a value obtained by (calculated theoretical throughput) ×(acceleration ratio average X) with a value of the bandwidth (throughput) that can be assigned to the wireless terminal 100. If the former is larger than the latter, the acceleration ratio average X is kept without any change, and if the latter is larger than the former, a value obtained by dividing the value of the bandwidth that can be assigned to the wireless terminal 100 by the calculated theoretical throughput can be set as the acceleration ratio average X. In this example, the information collection server 107 can calculate the bandwidth that can be assigned to the wireless terminal 100, for example, through the following formula.

[Bandwidth assignable to wireless terminal 100]=[remaining wireless resource (the number of blocks)]×[the amount of data for each block transmittable by a modulation system associated with CQI]

In general, the base station 101 assigns the wireless resource to the wireless terminal on a block basis. How much the block can be efficiently used by the wireless terminal depends on a state of the wireless terminal (radio wave state), or the like, and information indicative of that state is CQI. The modulation system is recognized by the CQI number, thereby determining the amount of data transmittable for each block.

The information collection server 107 determines whether the acceleration ratio X exceeds a predetermined threshold value Th, or not. If the acceleration ratio X exceeds the threshold value Th, because there is a need to perform acceleration or to continue the acceleration, the information collection server 107 determines whether the acceleration flag corresponding to the wireless terminal 100 held in the management table 1400 (FIG. 14 to be described later) is on, or not. If the acceleration flag is not on, the information collection server 107 transmits an acceleration start request to the base station 101, and turns on the acceleration flag corresponding to the wireless terminal 100 (1309, 1310, 1311, 1312). If the acceleration flag corresponding to the wireless terminal 100 is on, the information collection server 107 does not perform any processing. As a result, an unnecessary communication from the information collection server 107 to the base station 101 can be eliminated. After the determination, the information collection server 107 waits for a predetermined time, for example, for b seconds, and returns to Step 1302 (1313). If the acceleration ratio average X falls below the threshold value Th in Step 1309, because there is a need to stop the acceleration or continue a state to stop the acceleration, the information collection server 107 determines whether the acceleration flag corresponding to the wireless terminal 100 held in the management table 1400 (FIG. 14 to be described later) is on, or not. If the acceleration flag is on, the information collection server 107 transmits the acceleration stop request to the base station 101, and turns off the acceleration flag (1314, 1315, and 1316). If the acceleration flag corresponding to the wireless terminal 100 is off, the information collection server 107 does not perform any processing. Similarly, after the determination, the information collection server 107 waits for a predetermined time, for example, for b seconds, and returns to Step 1302.

With the above steps, the information collection server 107 can determine whether the TCP packet communication of the wireless terminal 100 is accelerated, or not, on the basis of a past acceleration performance, a wireless environment (CQI) under which the wireless terminal 100 is placed in real time, and the wireless resource use rate of the base station 101, and can dynamically switch the acceleration of the TCP packet communication to another. The dynamic switching of the acceleration can cope with a variation in the acceleration effect caused by a change in the wireless environment unlikely to occur in the wired environment.

FIG. 14 illustrates a management table for managing a state of the wireless terminal by the information collection server 107 according to the present embodiment. The management table 1400 manages the ID of the wireless terminal, the acceleration flag, and the acceleration time, and manages the acceleration state of the wireless terminal by the aid of the acceleration flag used for the determination in FIG. 13. The information collection server 107 holds, as the acceleration time, a predetermine period of time, for example, for an accumulated acceleration time of one month, and the acceleration time can help the billing of the wireless terminal.

Each of the tables in FIGS. 10 and 11 may be provided in the base station 101 so as to be shared by the multiple wireless terminals. In that case, the base station 101 and the information collection server 107 execute the respective processing on the TCP packet communications of the respective wireless terminals with the use of the respective common tables. On the other hand, each table in FIGS. 10 and 11 may be installed for each of the wireless terminals 100, and in that case, the wireless terminal ID is notified the base station 101 and the information collection server 107 of by the aid of the TCP packet communication start notice (Step 702) or the like and is held therein. The base station 101 and the information collection server 107 store information in each table for each wireless terminal ID, and execute the respective processing in association with the wireless terminal ID.

### 3. Effects of the Embodiment

In the present embodiment, when the TCP packet communication acceleration technique is applied to the wireless communication network, the acceleration effect is determined according to various pieces of information in real time, and the acceleration control is dynamically performed, thereby being capable of effectively accelerating the communication using the TCP of the wireless terminal existing in the wireless communication network.

### 4. Additional Statement

The above description has been given of, as an example, a case in which the notification information from the base station 101 to the information collection server 107 includes the RTT, the PLR, the wireless resource use rate, and the CQI, and the various pieces of information (measurement information) to be measured by the base station 101 includes the RTT, the PLR, the wireless resource use rate, the CQI, and the measured throughput. The present invention and the present embodiment are not limited to the above configurations, but the notification information can include network quality information indicative of a communication quality of the RTT, the PLR, or another network or line, and wireless communication quality information indicative of a communication quality of the wireless resource use rate, the CQI, or another wireless line. Likewise, the measurement information can include the above network quality information, the above wireless communication quality information, and the measured throughput.

The present invention is not limited to the above embodiments, but includes various modified examples. For example, in the above-mentioned embodiments, in order to easily understand the present invention, the specific configurations are described.

However, the present invention does not always provide all of the configurations described above. Also, a part of one configuration example can be replaced with another configuration example, and the configuration of one embodiment can be added with the configuration of another embodiment. Also, in a part of the respective configuration examples, another configuration can be added, deleted, or replaced.

Also, parts or all of the above-described respective configurations, functions, processors, processing means may be realized, for example, as an integrated circuit, or other hardware. Also, the above respective configurations and functions may be realized by allowing the processor to interpret and execute programs for realizing the respective functions. That is, the respective configurations and functions may be realized by software. The information on the program, table, and file for realizing the respective functions can be stored in a storage device such as a memory, a hard disc, or an SSD (solid state drive), or a storage medium such as an IC card, an SD card, or a DVD.

Also, the control lines and the information lines necessary for description are illustrated, and all of the control lines and the information lines necessary for products are not illustrated. In fact, it may be conceivable that most of the configurations are connected to each other.

Although the present disclosure has been described with reference to exemplary embodiments, those skilled in the art will recognize that various changes and modifications may be made in form and detail without departing from the spirit and scope of the claimed subject matter.

What is claimed is:

1. A wireless communication system, comprising:
a server having a server table that stores measurement information including network communication quality information, wireless communication quality information, and a measured throughput, an acceleration ratio, and a file size; and
a base station that starts or stops acceleration processing of a packet communication under a control from the server, wherein
upon receiving a packet communication start notice and a file size from a wireless terminal in a state where the acceleration processing of the base station stops, the server transmits a notification start notice to the base station,
the base station notifies the server of notification information including network communication quality information and wireless communication quality information,
the server calculates an acceleration ratio average indicative of an average of a plurality of acceleration ratios on the basis of a predetermined policy according to the notification information, the file size, and information stored in advance in the server table, performs acceleration determination for starting or stopping the acceleration processing of a packet communication of the wireless terminal according to the acceleration ratio average, and transmits an acceleration start request and an information acquisition start notice to the base station when it is determined that the acceleration processing starts, and
the base station starts the acceleration processing of the packet communication of the wireless terminal, and measures and stores measurement information including the network communication quality information, the wireless communication quality information, and the measured throughput at every predetermined time interval,
upon receiving a packet communication end notice from the wireless terminal, the server transmits an acceleration stop request and an information acquisition end notice to the base station,
the base station stops the acceleration processing of the packet communication of the wireless terminal, terminates the measurement of the measurement information, and transmits the plurality of measurement information measured during the acceleration processing to the server, and
the server calculates a theoretical throughput from the network communication quality information on the basis of the plurality of measurement information, divides the measured throughput by the theoretical throughput to obtain the acceleration ratio, and stores the measurement information, the acceleration ratio, and the file size in the server table at the every predetermined time interval.

2. The wireless communication system according to claim 1, wherein
in a state where the packet communication of the wireless terminal starts, and the acceleration processing of the base station starts,
the server receives the notification information from the base station, performs the acceleration determination, and transmits the acceleration stop request and the information acquisition end notice to the base station when it is determined to stop the acceleration processing of the packet communication of the wireless terminal,
the base station stops the acceleration processing, finishes the measurement of the measurement information, and transmits the plurality of measurement information measured during the acceleration processing to the server, and the server calculates the theoretical throughput from the network communication quality information on the basis of the plurality of measurement information, divides the measured throughput by the theoretical throughput to obtain the acceleration ratio, and stores the acceleration ratio, the file size, and the measurement information in the server table at the every predetermined time interval.

3. The wireless communication system according to claim 2, wherein
upon receiving the packet communication end notice from the wireless terminal in a state where the base station stops the acceleration processing, the server further transmits the notification end notice to the base station, and
the base station finishes the notification of the notification information.

4. The wireless communication system according to claim 1, wherein
upon receiving the packet communication start notice and the file size from the wireless terminal or another wireless terminal in a state where the base station accelerates all of the packet communications, the server transmits the information acquisition start notice to the base station,
the base station measures and records the measurement information at every predetermined time interval, and
upon receiving the packet communication end notice from the wireless terminal or the another wireless terminal, the base station transmits the information acquisition end notice to the base station,
the base station transmits the plurality of measurement information to the server, and
the server calculates the theoretical throughput from the network communication quality information on the basis of the plurality of measurement information, divides the measured throughput by the theoretical throughput to obtain the acceleration ratio, and stores the acceleration ratio, the file size, and the measurement information in the server table at the every predetermined time interval.

5. The wireless communication system according to claim 1, wherein
the base station notifies the server of the notification information in a fixed interval during the packet communication of the wireless terminal, and
the server does not transmit the acceleration start request or the acceleration stop request to the base station when a state of starting or stopping the acceleration processing of the base station is identical with a determination result of the acceleration determination.

6. The wireless communication system according to claim 1, wherein
the server acquires the notification information from the base station at fixed intervals when the server does not receive the packet communication end notice from the wireless terminal, and
the server calculates the acceleration ratio average on the basis of the predetermined policy according to the file size received from the wireless terminal and the notification information received from the base station with reference to the server table.

7. The wireless communication system according to claim 1, wherein
the server determines whether the acceleration ratio average exceeds a predetermined threshold value, or not, and starts the acceleration processing or continues an acceleration state if the acceleration ratio average exceeds the threshold value, and stops the acceleration processing or continues a acceleration stop state if the acceleration ratio average falls below the threshold value.

8. The wireless communication system according to claim 1, wherein
the server obtains an acceleration ratio average candidate by averaging a predetermined number of acceleration ratios obtained by sorting the information of the server table on the predetermined policy according to the file size and the network communication quality information of the notification information, and
the server calculates an assignable throughput that can be assigned to the wireless terminal from the wireless communication quality information of the notification information, compares an integrated value of the theoretical throughput calculated on the basis of the network communication quality information of the notification information and the acceleration ratio average candidate with the assignable throughput, and sets the acceleration ratio average candidate as the acceleration ratio average if the integrated value is larger than the assignable throughput, and sets a value obtained by dividing the assignable throughput by the theoretical throughput as the acceleration ratio average if the integrated value is smaller than the assignable throughput.

9. The wireless communication system according to claim 1, wherein
the server further includes a management table that stores an acceleration flag indicative of the start or stop of the acceleration processing for a wireless terminal ID, and
the server obtains the acceleration flag according to the wireless terminal ID received from the wireless terminal in advance with reference to the management table when receiving the packet communication end notice from the wireless terminal, and
the server transmits the acceleration stop request of the packet communication of the wireless terminal to the base station when the acceleration flag corresponding to the wireless terminal starts, and terminates the processing when the acceleration flag corresponding to the wireless terminal stops.

10. The wireless communication system according to claim 1, wherein
upon receiving the packet communication start notice from the wireless terminal, the server transmits the notification start notice to the base station,
the server receives the notification information from the base station during the packet communication of the wireless terminal at fixed intervals, and
the server transmits the notification end notice to the base station when receiving the packet communication end notice from the wireless terminal.

11. The wireless communication system according to claim 1, wherein
the network communication quality information includes a round trip rate (RTT) and a packet loss rate (PLR), and
the wireless communication quality information includes a wireless resource use rate and a channel quality indicator (CQI).

12. The wireless communication system according to claim 11, wherein
the server obtains the theoretical throughput by multiplying an average number of congestion windows by the number of bits in one packet, and dividing a multiplied numerical value by an RTT.

13. The wireless communication system according to claim 11, wherein
the server obtains the theoretical throughput by
1.2/sqrt (PLR) *MSS*8/RTT
when MSS is a maximum segment size acquired from the base station at the time of starting the packet communication.

14. A server, comprising:
a server table that stores measurement information including network communication quality information, wireless communication quality information, and a measured throughput, an acceleration ratio, and a file size; and
a control unit that controls start or stop of acceleration processing for a base station, wherein
upon receiving a packet communication start notice and a file size from a wireless terminal in a state where the acceleration processing of the base station stops, the control unit transmits a notification start notice to the base station,
upon receiving notification information including network communication quality information and wireless communication quality information from the base station,
the control unit calculates an acceleration ratio average indicative of an average of a plurality of acceleration ratios on the basis of a predetermined policy according to the notification information, the file size, and information stored in advance in the server table, performs acceleration determination for starting or stopping the acceleration processing of a packet communication of the wireless terminal according to the acceleration ratio average, and transmits an acceleration start request and an information acquisition start notice to the base station when it is determined that the acceleration processing starts,
to make the base station start the acceleration processing of the packet communication of the wireless terminal, and measure and store measurement information including the network communication quality information, the wireless communication quality information, and the measured throughput at every predetermined time interval,
upon receiving a packet communication end notice from the wireless terminal, the control unit transmits an acceleration stop request and an information acquisition end notice to the base station,
when the base station stops the acceleration processing of the packet communication of the wireless terminal, terminates the measurement of the measurement information, and the control unit receives the plurality of measurement information measured during the acceleration processing from the base station,
the control unit calculates a theoretical throughput from the network communication quality information on the basis of the plurality of measurement information, divides the measured throughput by the theoretical throughput to obtain the acceleration ratio, and stores the measurement information, the acceleration ratio, and the file size in the server table at the every predetermined time interval.

15. A base station, comprising:
a base station table that stores measurement information including network communication quality information, wireless communication quality information, and a measured throughput;
a control unit; and
a packet acceleration unit that starts or stops acceleration processing of a packet communication under a control from a server, wherein,
when the server receives a packet communication start notice and a file size from a wireless terminal in a state where the acceleration processing of the base station stops, upon receiving a notification start notice from the server,
the control unit notifies the server of notification information including network communication quality information and wireless communication quality information,
when the server calculates an acceleration ratio average indicative of an average of a plurality of acceleration ratios on the basis of a predetermined policy according to the notification information, the file size, information stored in advance in a server table that stores measurement information including network communication quality information, wireless communication quality information, and a measured throughput, an acceleration ratio, and a file size, performs acceleration determination for starting or stopping the acceleration processing of a packet communication of the wireless terminal according to the acceleration ratio average, upon receiving an acceleration start request and an information acquisition start notice from the server when it is determined that the acceleration processing starts,
the control unit starts the acceleration processing of the packet communication of the wireless terminal by the packet acceleration unit, and measures measurement information including the network communication quality information, the wireless communication quality information, and the measured throughput at every predetermined time interval, and stores the measurement information,
when the servers receives a packet communication end notice from the wireless terminal, upon receiving an acceleration stop request and an information acquisition end notice from the server,
the control unit stops the acceleration processing of the packet communication of the wireless terminal by the packet acceleration unit, terminates the measurement of the measurement information, and, by referring to the base station table, transmits the plurality of measurement information measured during the acceleration processing to the server,
to make the server calculate a theoretical throughput from the network communication quality information on the basis of the plurality of measurement information, divide the measured throughput by the theoretical throughput to obtain the acceleration ratio, and store the measurement information, the acceleration ratio, and the file size in the server table at the every predetermined time interval.
